(19) United States
(12) Patent Application Publication
(10) Pub. No.: US 2005/0063116 A1
(43) Pub. Date: Mar. 24, 2005

(54) Power cord with monitor circuit

(76) Inventor: Dave Rotheroe, Dallas, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/670,033

(22) Filed: Sep. 24, 2003

(51) Int. Cl. H02H 3/26

(52) U.S. Cl. 361/90

(57) ABSTRACT

A measurement device for an electrical apparatus, consistent with certain embodiments has a power cord for providing electrical energy to the electrical device. A measurement circuit is embedded within the power cord to measure a parameter of the electrical energy supplied to the electrical device, and provides an output signal indicative of the parameter of the electrical energy.

### CROSS REFERENCE TO RELATED DOCUMENTS

This application is related to the co-pending U.S. patent application identified by Ser. No. ______, being further identified by Docket Number 200300847-1, filed of even date herewith, entitled “Electrical Equipment Monitoring” by Rotheroe, which has the same ownership as the present application and to that extent is related to the present application and which is hereby incorporated by reference.

### BACKGROUND

Several techniques are currently in use to measure the current drawn by a piece of electrical equipment. Using one technique, the current can be measured by use of a current meter that clamps around the power cord of alternating current (AC) powered equipment. In this technique, the power cord induces current into a secondary coil in the current meter that permits measurement of the current. In another technique, the power line is open circuited with a current meter disposed in series with one of the power lines.

These techniques might be used by service technicians seeking to determine a current associated with a piece of equipment. However, there is generally no mechanism in place to remotely monitor the current consumed by a piece of electrical equipment such as a computer or multiple computers.

### BRIEF DESCRIPTION OF THE DRAWINGS

FIG. 1 is a block diagram depicting a power cord with a current measuring circuit built in, in a manner consistent with certain embodiments.

FIG. 2 is a circuit diagram of an exemplary circuit that can measure current and voltage in a manner consistent with certain embodiments.

FIG. 3 is another block diagram depicting a power cord with a current measuring circuit built in, in a manner consistent with certain embodiments.

FIG. 4 shows an example configuration of a measurement circuit disposed within a power cord in a manner consistent with certain embodiments.

FIG. 5 shows another example configuration of a measurement circuit disposed within a power cord in a manner consistent with certain embodiments.

FIG. 6 shows yet another example configuration of a measurement circuit disposed within a power cord in a manner consistent with certain embodiments.

FIG. 7 shows still another example configuration of a measurement circuit disposed within a power cord in a manner consistent with certain embodiments.

FIG. 8 shows another example configuration of a measurement circuit disposed within a power cord in a manner consistent with certain embodiments.

FIG. 9 is a block diagram illustrating the connection of current measurement circuits with an intelligence module and a computer network.

FIG. 10 is a block diagram of a measurement module circuit consistent with certain embodiments.

FIG. 11 is a flow chart of a method consistent with certain embodiments.

FIG. 12 is a flow chart of another method consistent with certain embodiments.

FIG. 13 is a flow chart of another method consistent with certain embodiments.

### DETAILED DESCRIPTION

There is shown in the drawings and will herein be described in detail specific embodiments, with the understanding that they are to be considered as exemplary and are not intended to be limiting. In the description below, like reference numerals are often used to describe the same, similar or corresponding parts in the several views of the drawings.

There are many applications where it would be desirable to measure the current of a piece of data processing equipment or other electrical equipment on a regular basis, and without the use of temporary setups. One exemplary embodiment might be in a computer room containing multiple computers that are interconnected to service a large scale web site, or a database service. In such a situation, an increase in current might provide early warning that a piece of equipment is about to fail or has failed. Other environments can also benefit from the ability to remotely detect an increase in current being consumed by a piece of electrical equipment. Other electrical parameters may also provide similar insight into the status of the equipment.

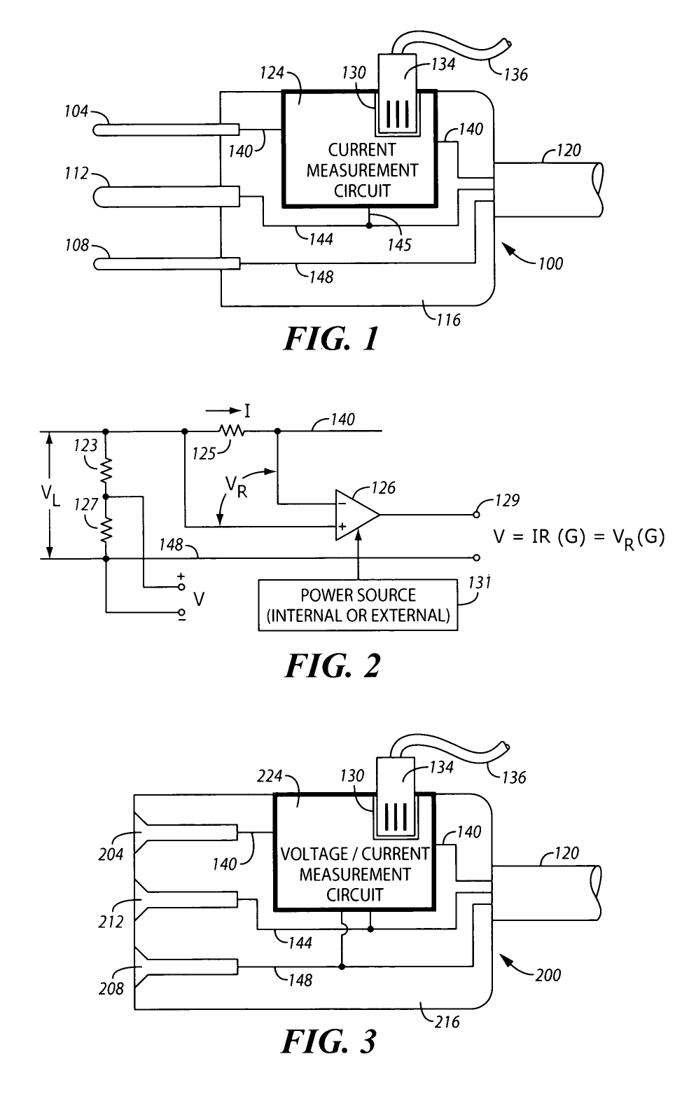

With reference to FIG. 1, a power cord is depicted into which a current measurement circuit is fabricated. In this embodiment, a power plug (the male connector of the power cord) depicted generally as 100 has the conventional “hot”, “neutral” and “ground” prongs 104, 108 and 112 extending from a plug housing 116. The neutral and ground prongs 108 and 112 are connected to appropriate gauge wires (148 and 144 respectively) that extend from body 116 to a piece of equipment or alternately to a connector (e.g., a female power connector) that in turn is used to connect to the equipment through an appropriate wire jacket 120. The hot prong 104 is connected to hot wire 140 which is also passed to the equipment or connector through jacket 120, but may be interrupted to pass through a current measurement circuit. Current measurement circuit 124 may also connect to the ground wire as shown or to the neutral wire depending upon the nature of operation of the circuit 124.

Several types of circuits are known for carrying out measurement of various circuit parameters. One exemplary circuit for measurement of current is depicted in FIG. 2. In this circuit, a small resistance 125 (which may be the resistance of a piece of wire or a circuit board runner can be generally inserted in a circuit pathway where the current (I) is to be measured. The voltage drop (V) across that resistance is measured. Under Ohm's law, that voltage is proportional to the current passing through the resistance (V=IR). Using a differential amplifier circuit such as 126, the voltage drop V can be amplified to scale the voltage to a more easily readable voltage range. That voltage may then be presented as an output of the current measurement circuit, or that voltage may be converted to another signal representative of the level of current passing through the small resistance (e.g., it may be converted to digital and digitally encoded). In the example illustrated in FIG. 2, the voltage out (V_{OUT}) at the differential amplifier 126 is equal to the differential voltage gain (G) multiplied by the product of the current (I) and the resistance (R) of resistor 125. This signal at output terminal 129 can be used in analog form or converted to digital using an analog to digital converter as an indication of the current through the resistor 125. The current can then be derived from l=V_{OUT}/(RG). The differential amplifier 126 can be powered using any number of conventional power sourcing techniques, such as for example, a circuit that derives power from the power line wires 140 and 148, a battery, an external power supply or any other suitable source of DC bias—depicted generally as power source 131. In other embodiments, the signal at terminal 129 can be converted to a digital signal or to a signal that has been otherwise processed (e.g., comparison to a threshold or converted to a current or power value) before being made available as an output.

The input voltage (line voltage V_{L}) can be directly measured or can be reduced to a safe value using a voltage divider circuit as depicted using a pair of series connected (preferably) large value resistors 123 and 127. The output of the voltage divider can then be used as a representation of the line voltage, where V_{L}=V_{D}D where D is the voltage divider's divide ratio. In other embodiments, this value can be converted to DC, amplified, converted to a digital value or otherwise processed before being provided as an output from the measurement circuit module.

In other embodiments, an inductive coupling to the line carrying the current to be measured can be used to measure current. In this technique, a small inductance (perhaps only the inductance of a straight or curved wire or circuit runner) forms a transformer primary which is magnetically coupled to an secondary coil. The signal induced into the secondary coil is dependent upon the amount of current present in the primary and can be derived therefrom in a known manner.

Integrated current measurement circuits suitable for use in making current measurements are commercially available from a number of manufacturers. One example is manufactured and commercially supplied by CR Magnetics as Current Sensor part number CR9521-20 (20 amp range) which directly supplies a 0 to 5 volt output representative of a range of current. Therefore, in one embodiment, the current measurement circuit 124 may be implemented using this commercially available part with the 0 to 5 volt output supplied through connector 130. Thus, connections to circuit 124 may be made to (through) the hot wire 140 and to the ground wire 144 as indicated at 145. Connections may also be made to the neutral wire 148 in certain embodiments (for example, if current measurement circuit 124 derives operational power from the power line flowing through the power cord 100 by use of an AC to DC converter circuit forming a part of the measurement circuit 124). In certain embodiments consistent herewith, a low cost custom circuit can be developed for the current and or voltage measurement (or other parameter measurement) application.

In any case, the signal produced by the current measurement circuit can be made available at an output terminal (e.g., terminal 129 or a signal derived therefrom) that is accessed by providing an electrical connector 130 which mates with a mating electrical connector 134 that is electrically connected by signal wire 136 to an intelligence module or a computer or network adapter as will become clear later. Any suitable commercially available mating electrical connector pair can be used for connectors 130 and 134, or custom designed connectors can be used. This allows the signal representative of the current in the power cord to be sent to a remote location for monitoring using signal wire 136. In other embodiments, other methods of communication with the remote location may be used as will be described.

With reference to FIG. 3, a similar arrangement can be provided for an equipment end of a power cable. In this embodiment, a female connector shown generally as 200 such as that commonly used with a piece of computer equipment that is to be tested (often referred to as the Device Under Test, or DUT) is depicted in which female hot, neutral and ground connections correspond to sockets 204, 208 and 212 that are connected to a socket housing 216. In this embodiment, a circuit 224 is provided for measurement of both voltage and current. The circuit of FIG. 3 might be suitable for certain applications. As such, a connection is made both to voltage measurement circuit 224 with the hot wire 140 to socket 204 and to the neutral wire 148 and socket connection 208. A ground connection to ground wire 144 may also be made.

In certain embodiments, direct current (DC) power used for operation of the current monitoring circuit can be generated locally within the measurement circuits 124 and 224 by inclusion therein of AC to DC converting circuitry which converts alternating current from lines 140 and 148 to direct current in order to provide power to measurement circuit 200. In other embodiments, DC power can be supplied through connector 134 from a remote location. In still other embodiments, the measurement circuit can operate passively. In still other embodiments, a local power source that is separately connected to AC power can be used or the measurement device could be battery powered. Many other variations of mechanisms to provide power to the measuring circuit are within the ordinary skill in the art and will become evident upon consideration of the present teaching.

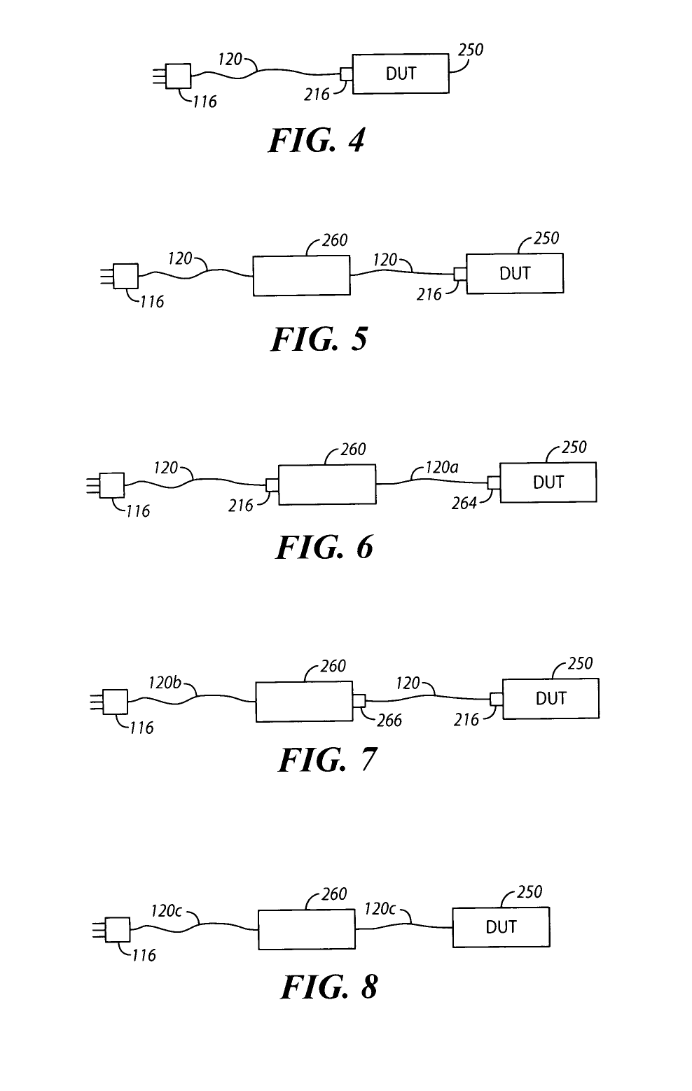

With reference to FIG. 4, and in accordance with the above described embodiments, a measurement circuit can be embedded within either the male plug end housing 116 (which plugs into a wall outlet or extension thereof) or the female socket end housing 216 which attaches directly to a DUT 250 in the manner of a conventional power cord 120 as described. Other embodiments are also possible.

FIG. 5 shows an example of a measurement circuit 260 that measures any suitable electrical parameter situated within the power cord 120 between the plug end housing 116 and the socket end housing 216. In this example embodiment, the measurement circuit 260 is permanently connected to and forms a part of the power cord 120 and mates with the DUT 250 using connector 216. Any suitable arrangement of cord lengths for the cord segments of cord 120 can be used.

FIG. 6 shows an example of measurement circuit 260 in which an equipment side 120a of the power cord is permanently attached to the measurement circuit 260. A conventionally configured power cord 120 can then be attached to the measurement circuit by plugging socket end housing 216 into the measurement circuit 260 using a mating plug. The measurement circuit 260 may have any suitable female plug member 264 that plugs into the DUT. In variations of this embodiment, the power cord 120 can be a so called “pig tail” cord which is somewhat short and detachable from the measurement circuit 260. In other variations, the power cord 120a is short and the main power cord 120 is longer. Any combinations of lengths of cord 120 and 120a can be used as desired.

FIG. 7 shows an example of measurement circuit 260 that is permanently attached to power cord 120b at the side closest to plug housing 116 as shown. The other side can be connected using a female connector that mates with the male connector of a conventional power cord 120 or uses any other suitable connector 266 so that the DUT ultimately receives power through connector 216. As with the above example of FIG. 6, any suitable arrangement of lengths of the power cords and any suitable connectors can be used.

FIG. 8 shows an example of the measurement circuit 260 that measures any suitable electrical parameter situated within the power cord 120 between the plug end housing 116 and the socket end housing 216. In this example embodiment, the measurement circuit 260 is permanently connected to and forms a part of the power cord 120c. Power cord 120c is, in this example, permanently attached to the DUT 250 without use of a connector such as connector 216. In each of the above examples, the measurement circuit can be referred to as a measurement module when embedded within the plug, socket or other housing—either alone or along with other circuitry.

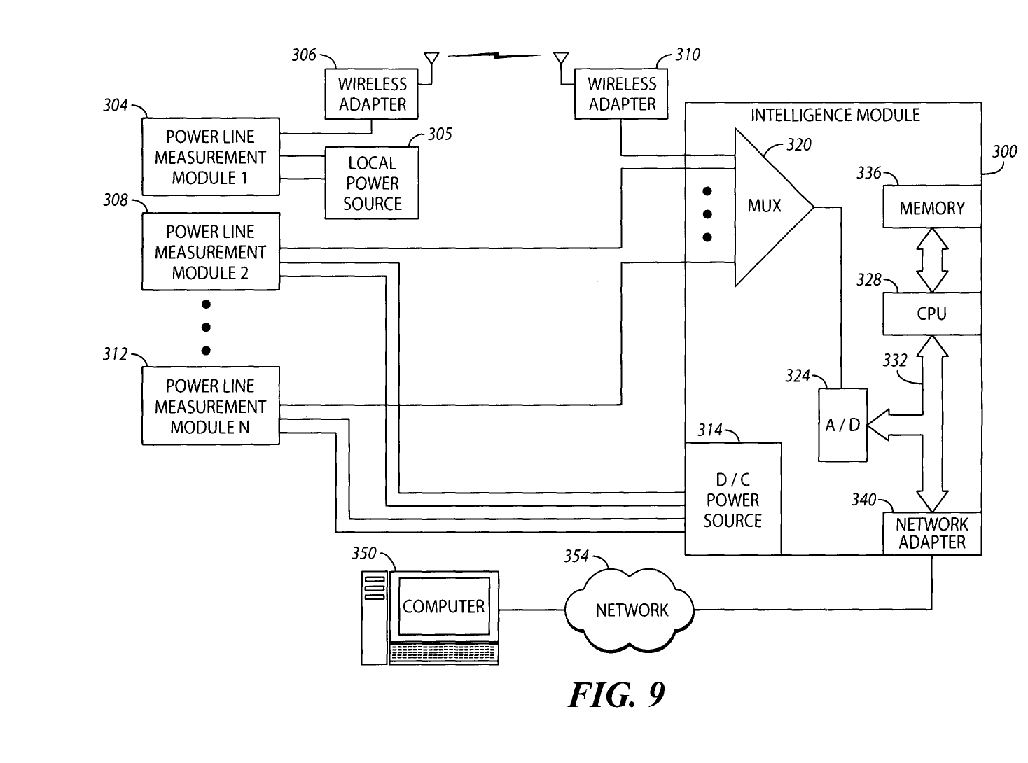

In order to maintain a low costs, the power cord may only contain the current measuring circuitry in accordance with certain preferred embodiments. This circuitry is connected via the connectors 134 and wires 136 to an intelligence module 300 as depicted in FIG. 9. Intelligence module 300 does the analysis of the data coming from the various measurement circuits and makes it available to any suitable computer device that is attached to the intelligence module 300. The intelligence module 300 allows the aggregation of multiple monitored power cords to a single address (e.g., an Internet protocol address). Availability of the data from the intelligence module 300 can be provided using an Ethernet connection, SNMP (Simple Network Management Protocol), serial, or any other suitable interface method.

In other embodiments, the measurement module may carry out more sophisticated functions such as comparing the measured value to a threshold and communicating an alarm signal, e.g., through a connection of connector 130, when a threshold has been exceeded.

In the example shown in FIG. 9, a plurality of N power cord measurement modules 304, 308, and 312 are connected to the male or female connectors of N power line cords (or situated anywhere along the power cord). These measurement modules are connected via connectors analogous to 134 and wires 136 to the intelligence module 300 in the case of modules 308 and 312. Module 304 is connected to a wireless adapter 306 (or contains an integrated wireless adapter) which communicates wirelessly (e.g., using RF, ultrasonic, infrared or other wireless technology) to a similar wireless adapter 301 connected to the Intelligence module 300. In other embodiments, wireless adapter 306 could also be embedded within the measurement module rather than being a separate device. Intelligence module 300, in this particular example, also provides DC power (e.g., 5 volts DC) via a pair of wires (+ and −) to the power cord measurement modules 308 and 312 from DC power source 314. The module 304 receives power from a local power source 305 such as an external power adapter, an internal AC to DC converter or a battery. In this example analog voltage levels representative of the current being measured are received at the intelligence module 300. These voltages are multiplexed at a multiplexer (MUX) 320 to provide their outputs to an analog-to-digital converter (A/D) 324. These values can then be read by a microprocessor or microcontroller such as Central Processing Unit (CPU) 328 via a bus connection 332 to the A/D 324. CPU 328 then converts the input to a current value and stores that current value in a memory 336. In other embodiments, mass storage such as a disk drive could also be provided in the intelligence module.

A network adapter 340 (or other I/O port adapter, either wired or wireless) can also be interfaced to the CPU 328 via bus 332, or any other suitable interface technique, so that the intelligence module can be queried or addressed by computer such as computer 350. In this example, the intelligence module is provided with an Internet Protocol (IP) address and the network adapter 340 (e.g., a wired or wireless Ethernet adapter) allows the computer 350 to access the data stored in memory 336 via a computer network 354 such as the Internet, a Local Area Network (LAN) or a Wide Area Network (WAN).

The intelligence module 300 can be configured to store current data or to provide historical data along with providing analysis functions. In one example, a set of historical data can be provided upon being queried. In another embodiment, the intelligence module 300 can be programmed with current limits so that when those limits (i.e., upper and lower current thresholds) are reached, the circuit is assumed to be malfunctioning and an alarm signal can be sent to a designated location so that a warning message or problem report is generated.

Intelligence module 300 may form a part of, or interface with, a system such as that described in the above-referenced copending patent application, which involves monitoring of circuit parameters such as heat dissipation. In this environment, intelligence module 300 can send current and/or voltage information to computer 350, where computer 350 forms a part of the network monitoring arrangement disclosed in the above-referenced patent application. In other embodiments, the computer 350 can address the intelligence module 300 to obtain information on the measured operational parameters of the various devices under test for direct readout or printout by an operator. Other mechanisms for utilization of the information from the intelligence module 300 will occur to those skilled in the art upon consideration of the current teachings.

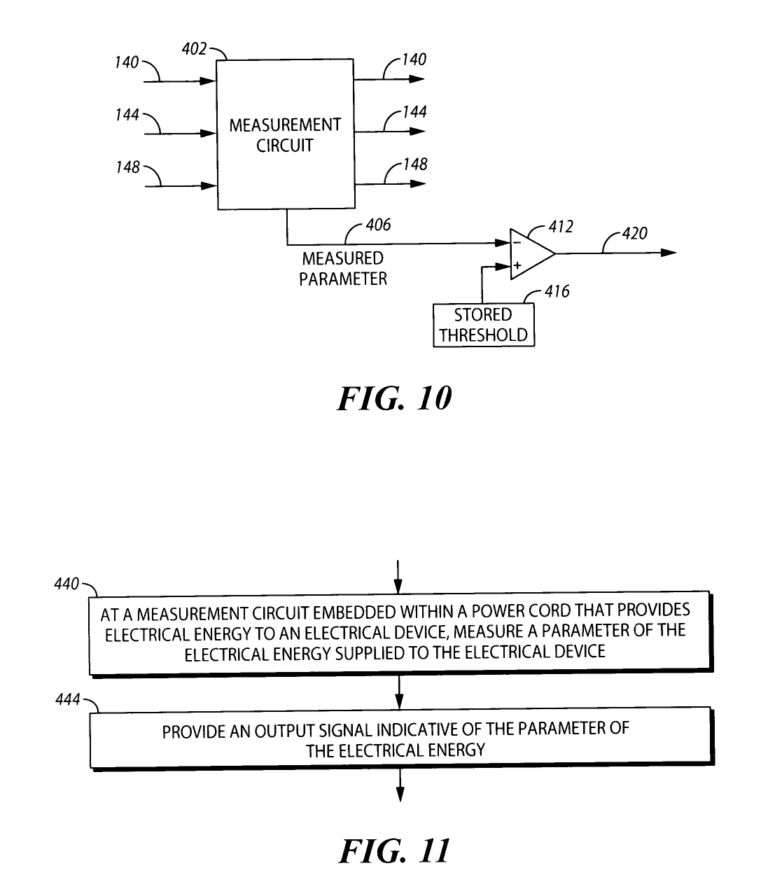

While the example depicted in FIG. 9 illustrates current measurement in power cord measurement modules 304, 308 and 312, any other suitable parameter that can be derived from the voltage, current or other power line signal can equally well be sent to the intelligence module and stored. Suitable alarms can similarly be generated whenever any such electrical parameter falls outside the bounds of an established upper and lower threshold if desired. Such alarms are preferably generated in the Intelligence module 300, but in certain embodiments could also be generated by the measurement module as depicted in FIG. 10. In this embodiment, a measurement circuit 402 measures a parameter and produces an output at 406. This parameter is compared at a comparator or other comparison circuit 412 with a stored threshold 416. An output 420 indicates whether or not the measured parameter at 406 exceeds the stored threshold 416. Comparison circuit 412 output 420 can be supplied to the intelligence module 300 through a wired connection such as provided by connector 130 or by any other suitable mechanism such as a wireless connection provided by an internal or external wireless adapter. Moreover, the comparator 412 and stored threshold 416 can also be situated at the Intelligence module 300 with the measured parameter 406 passing through connector 130. In such an embodiment, the threshold comparison can be carried out in the comparator 412 in the analog domain rather than at CPU 328 in the digital domain. Other variations will also occur to those skilled in the art upon consideration of the present teachings.

While the above exemplary embodiments have been described in terms of a conventional power cord for U.S. 120 volt line current, this should not be considered limiting. Certain embodiments can equally well be implemented in conjunction with power cords that are standard to other countries and power cords that operate with different wire configurations, different numbers of wires, or using different line voltages than the conventional three wire 120 volt, 60 Hz United States standard. In addition, in some applications, the power cord may carry two hot wires and one ground, or one hot and a neutral. Moreover, some power cords may be set up to handle multiple phase power (e.g., three phase power with three phases plus neutral or ground). Upon consideration of the exemplary embodiments described above, it will be clear to those skilled in the art that certain embodiments can be readily adapted to accommodate such variations. In such variations, one or multiple currents or voltages or other circuit parameters can be measured.

As described above, a measurement device for an electrical apparatus, consistent with certain embodiments has a power cord for providing electrical energy to the electrical device. A measurement circuit is embedded within the power cord to measure a parameter of the electrical energy supplied to the electrical device, and provides an output signal indicative of the parameter of the electrical energy.

In certain embodiments, a measurement device for an electrical apparatus has a power cord that provides electrical energy to the electrical device, the power cord having a male plug end and a female receptacle end. A current measurement circuit is embedded within the power cord to measure a parameter of the electrical energy supplied to the electrical device. An output of the measurement circuit provides a signal indicative of the parameter of the electrical energy. An electrical connector connects the output of the measurement circuit to an external circuit.

An intelligence module consistent with certain embodiments is used in conjunction with a measurement device for an electrical apparatus. The intelligence module has an input that receives a representation of an electrical parameter from at least one measurement circuit embedded within an electrical power cord. An analog to digital converter converts the representation to a value associated with the electrical parameter. A memory is provided and a processor stores the representation to the memory.

In another embodiment, a measurement device for an electrical apparatus has a power cord for providing electrical energy to the electrical device and has a measurement circuit embedded within the power cord for measuring a parameter of the electrical energy supplied to the electrical device. A circuit is provided for providing an output signal indicative of the parameter of the electrical energy.

An intelligence module for a measurement device for an electrical apparatus consistent with certain embodiments has a mechanism for receiving an input representing an electrical parameter from at least one measurement circuit embedded within an electrical power cord. A circuit for converting the representation to a digital value associated with the electrical parameter is provided, along with a circuit for storing the representation to the memory.

In accordance with certain embodiments, a method is provided for measuring an electrical parameter in a manner as depicted in FIG. 11. In this exemplary method, at a measurement circuit embedded within a power cord that provides electrical energy to an electrical device, a parameter of the electrical energy supplied to the electrical device is measured at 440. An output signal indicative of the parameter of the electrical energy is provided at 444.

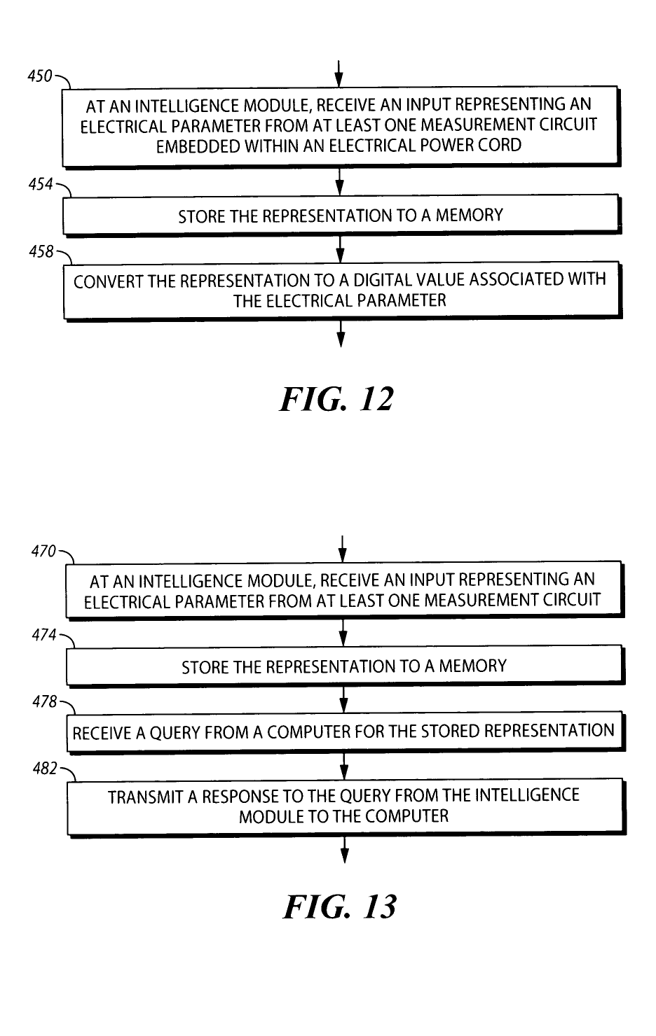

An exemplary method for measuring an electrical parameter is shown in FIG. 12, wherein at an intelligence module, an input representing an electrical parameter from at least one measurement circuit embedded within an electrical power cord is received at 450. The representation is converted to a digital value associated with the electrical parameter at 454. The representation is stored to a memory at 458.

The measured parameter need not always originate at a power cord measurement module as shown in the method of FIG. 13. In this exemplary embodiment, a method for measuring an electrical parameter involves, at an intelligence module, receiving an input representing an electrical parameter from at least one measurement circuit at 470; storing the representation to a memory at 474; receiving a query from a computer for the stored representation at 478; and transmitting a response to the query from the intelligence module to the computer at 482.

Thus, in accordance with certain embodiments, a measurement device for an electrical apparatus consistent with certain embodiments has a power cord for providing electrical energy to the electrical device, the power cord having a male plug end and a female receptacle end. A current measurement circuit is embedded within the power cord that measures a parameter of the electrical energy supplied to the electrical device. An output of the measurement circuit provides a signal indicative of the parameter of the electrical energy and an electrical connector connects the output of the measurement circuit to an external circuit. An intelligence module receives and stores the output of the measurement circuit. A network interface permits a computer to query the intelligence module for the stored output via a network connection. The intelligence module compares the output with a threshold and generates an alarm signal if the output crosses the threshold.

Those skilled in the art will recognize that certain exemplary embodiments may be based upon use of a programmed processor such as CPU 328. However, this should not be considered limiting, since other embodiments could be implemented using hardware component equivalents such as special purpose hardware and/or dedicated processors. Similarly, general purpose computers, microprocessor based computers, micro-controllers, optical computers, analog computers, dedicated processors and/or dedicated hard wired logic may be equivalently used to construct alternative equivalent embodiments. While the A/D conversion is depicted as being in the intelligence module, in other embodiments, the A/D conversion can be carried out at the intelligence module with the parameters transmitted to the intelligence module in digital form. In other embodiments, the measurement module may be directly linked to or addressable by a computer without need to use an intermediate intelligence module. Other variations will occur to those skilled in the art.

Those skilled in the art will appreciate that the program instructions and associated data used to implement the embodiments described above can be implemented using disc storage as well as other forms of storage such as for example Read Only Memory (ROM) devices, Random Access Memory (RAM) devices; optical storage elements, magnetic storage elements, magneto-optical storage elements, flash memory, core memory and/or other equivalent storage technologies.

Certain aspects of certain embodiments, as described herein, can be implemented using a programmed processor executing programming instructions that are broadly described above and that can be stored on any suitable computer readable storage medium or transmitted over any suitable electronic communication medium. However, those skilled in the art will appreciate that the processes described above can be implemented in any number of variations and in many suitable programming languages. For example, the order of certain operations carried out can often be varied, additional operations can be added or operations can be deleted without departing from certain embodiments. Error trapping can be added and/or enhanced and variations can be made in user interface and information presentation.

It is therefore evident that many alternatives, modifications, permutations and variations will become apparent to those of ordinary skill in the art in light of the foregoing description.

1. A measurement device for an electrical apparatus, comprising:
a power cord that provides electrical energy to the electrical device;
a measurement circuit embedded within the power cord that measures a parameter of the electrical energy supplied to the electrical device, and provides an output signal indicative of the parameter of the electrical energy.

2. The measurement device according to claim 1, wherein the power cord comprises a male plug end and a female receptacle end, and wherein the measurement circuit is embedded within either the male plug end or the female receptacle end.

3. The measurement device according to claim 1, wherein the power cord has a male plug end and a female receptacle end and wherein the measurement circuit is situated between the male plug end and the female receptacle end.

4. The measurement device according to claim 1, wherein the measurement circuit measures at least one of current and voltage.

5. The measurement device according to claim 1, further comprising an electrical connector for connecting the output of the measurement circuit to an external circuit.

6. The measurement device according to claim 1, further comprising an intelligence module receiving the output signal from the measurement circuit and storing the output.

7. The measurement device according to claim 6, wherein the intelligence module comprises an interface that permits a computer to query the intelligence module for the stored output.

8. The measurement device according to claim 7, wherein the interface comprises a wired or wireless network interface.

9. The measurement device according to claim 6, wherein the intelligence module compares the output with a threshold and generates an alarm signal if the output crosses the threshold.

10. The measurement device according to claim 1, further comprising a comparator that compares the output with a threshold and generates an alarm signal if the output crosses the threshold.

11. The measurement device according to claim 1, further comprising an interface that permits a computer to query the intelligence module for the stored output.

12. The measurement device according to claim 11, wherein the interface comprises a wired or wireless network interface.

13. A measurement device for an electrical apparatus, comprising:
a power cord that provides electrical energy to the electrical device, the power cord having a male plug end and a female receptacle end;
a current measurement circuit embedded within the power cord that measures a parameter of the electrical energy supplied to the electrical device;
an output of the measurement circuit that provides a signal indicative of the parameter of the electrical energy; and
an electrical connector that connects the output of the measurement circuit to an external circuit.

14. The measurement device according to claim 13, wherein the measurement circuit further measures voltage.

15. The measurement device according to claim 13, further comprising an intelligence module receiving the output of the measurement circuit and storing the output.

16. The measurement device according to claim 15, wherein the intelligence module comprises a network interface that permits a computer to query the intelligence module for the stored output via a network connection.

17. The measurement device according to claim 13, wherein the intelligence module compares the output with a threshold and generates an alarm signal if the output crosses the threshold.

18. The measurement device according to claim 13, further comprising a comparator that compares the output with a threshold and generates an alarm signal if the output crosses the threshold.

19. The measurement device according to claim 13, further comprising an interface that permits a computer to query the intelligence module for the stored output.

20. The measurement device according to claim 19, wherein the interface comprises a wired or wireless network interface.

21. An intelligence module for a measurement device for an electrical apparatus, comprising:
an input that receives a representation of an electrical parameter from at least one measurement circuit embedded within an electrical power cord;
an analog to digital converter that converts the representation to a value associated with the electrical parameter;
a memory; and
a processor that stores the representation to the memory.

22. The intelligence module according to claim 21, further comprising an interface that permits a computer to query the intelligence module for the stored output.

23. The intelligence module according to claim 21, wherein the interface comprises a network interface.

24. The intelligence module according to claim 21, wherein the processor further compares the output with a threshold and generates an alarm signal if the output crosses the threshold.

25. The measurement device according to claim 21, wherein the input comprises means for receiving input signals from a plurality of measurement circuits embedded within a plurality of electrical cords.

26. The measurement device according to claim 25, wherein the means for receiving input signals comprises a multiplexer.

27. A measurement device for an electrical apparatus, comprising:
a power cord for providing electrical energy to the electrical device;
measurement means embedded within the power cord for measuring a parameter of the electrical energy supplied to the electrical device; and
means for providing an output signal indicative of the parameter of the electrical energy.

28. The measurement device according to claim 27, wherein the power cord comprises a male plug end and a female socket end, and wherein the measurement means is embedded within one of the plug end and the female socket end.

29. The measurement device according to claim 27, wherein the power cord has a male plug end and a female receptacle end and wherein the measurement circuit is situated between the male plug end and the female receptacle end.

30. The measurement device according to claim 27, wherein the measurement circuit measures at least one of current and voltage.

31. An intelligence module for a measurement device for an electrical apparatus, comprising:
means for receiving an input representing an electrical parameter from at least one measurement circuit embedded within an electrical power cord;
means for converting the representation to a digital value associated with the electrical parameter; and
means for storing the representation to the memory.

32. The intelligence module according to claim 31, further comprising an interface means for permitting a computer to query the intelligence module for the stored output.

33. The intelligence module according to claim 31, further comprising means for comparing the output with a threshold and generating an alarm signal if the output crosses the threshold.

34. The measurement device according to claim 31, wherein the means for receiving the input comprises means for receiving input signals from a plurality of measurement circuits embedded within a plurality of electrical cords.

35. A method of measuring an electrical parameter, comprising:
at a measurement circuit embedded within a power cord that provides electrical energy to an electrical device, measuring a parameter of the electrical energy supplied to the electrical device; and
providing an output signal indicative of the parameter of the electrical energy.

36. The method according to claim 35, wherein the power cord comprises a male plug end and a female receptacle end, and wherein the measurement circuit is embedded within one of the plug end and the receptacle end.

37. The method according to claim 35, wherein the power cord has a male plug end and a female receptacle end and wherein the measurement circuit is situated between the male plug end and the female receptacle end.

38. The method according to claim 35, wherein the measurement circuit measures at least one of current and voltage.

39. The method according to claim 35, further comprising sending the output signal to an intelligence module and storing the output signal at the intelligence module.

40. The method according to claim 39, querying the intelligence module to retrieve the stored output.

41. The method according to claim 40, further comprising comparing the stored output with a threshold and generating an alarm signal if the output crosses the threshold.

42. The method according to claim 35, further comprising comparing the output with a threshold and generating an alarm signal if the output crosses the threshold.

43. A method for measuring an electrical parameter, comprising:
at an intelligence module, receiving an input representing an electrical parameter from at least one measurement circuit embedded within an electrical power cord;
converting the representation to a digital value associated with the electrical parameter; and
storing the representation to a memory.

44. The method according to claim 43, further comprising querying the intelligence module for the stored output

45. The method according to claim 43, further comprising comparing the output with a threshold and generating an alarm signal if the output crosses the threshold.

46. The method according to claim 43, further comprising receiving input signals from a plurality of measurement circuits embedded within a plurality of electrical cords.

47. A method for measuring an electrical parameter, comprising:
at an intelligence module, receiving an input representing an electrical parameter from at least one measurement circuit;
storing the representation to a memory;
receiving a query from a computer for the stored representation; and
transmitting a response to the query from the intelligence module to the computer.

48. The method according to claim 47, wherein the computer addresses the query to the intelligence module using a network address.

49. The method according to claim 47, further comprising comparing the stored representation with a threshold and generating an alarm signal if the output crosses the threshold.

50. The method according to claim 49, further comprising sending the alarm to the computer.

51. The method according to claim 47, wherein the receiving comprises receiving the input signal from a measurement circuit embedded within an electrical cord.

52. The method according to claim 47, wherein the receiving comprises receiving input signals from a plurality of measurement circuits embedded within a plurality of electrical cords.
